(19) United States
(12) Patent Application Publication
(10) Pub. No.: US 2026/0216647 A1
(43) Pub. Date: Jul. 30, 2026

(54) TAIL GAS TREATMENT BY TWO STAGE ADSORPTION WITH INTERMEDIATE COOLING

(71) Applicant: Saudi Arabian Oil Company, Dhahran (SA)

(72) Inventors: Georgios Lithoxoos, Dhahran (SA); Milind M. Vaidya, Dhahran (SA); John O’Connell, Dhahran (SA); Sebastien A. Duval, Dhahran (SA); Feras Hamad, Dhahran (SA); Guillaume Robert Jean-Francois Raynel, Dhahran (SA); Olatunde O. Onasanya, Dhahran (SA)

(21) Appl. No.: 19/042,878

(22) Filed: Jan. 31, 2025

(30) Foreign Application Priority Data
Jan. 29, 2025 (GR) 20250100061

(51) Int. Cl. B01D 53/86; B01D 53/04; B01D 53/26; C01B 17/50

(52) U.S. Cl. CPC B01D 53/869; B01D 53/0438; B01D 53/261; B01D 53/263; B01D 53/265; B01D 53/8612; C01B 17/508; B01D 2253/116; B01D 2255/20746; B01D 2255/20753; B01D 2255/20769; B01D 2255/808; B01D 2257/302; B01D 2257/304; B01D 2257/306; B01D 2257/308; B01D 2257/80; B01D 2259/4009; C01P 2006/80

(57) ABSTRACT

A method and system for tail gas treatment includes reducing or hydrolyzing sulfur-containing gases in a tail gas stream to hydrogen sulfide, resulting in an effluent gas stream. Moisture is removed from the effluent gas stream by a quench tower. Water is further condensed from the effluent gas stream in an intermediate chiller before oxidizing the effluent gas stream. After oxidation, water is removed from the oxidized gas stream using a first adsorption bed that includes molecular sieves 3A. SO₂ is removed from the oxidized gas stream in a second adsorption bed that includes molecular sieves 5A. The first and second adsorption beds are regenerated to release water and SO₂. SO₂ is recycled back to the Claus unit.

### TECHNICAL FIELD

This application claims the benefit of priority to Greek application No. 20250100061, filed on Jan. 29, 2025, the contents of which are incorporated by reference herein.

This disclosure relates to the methods of treatment of sulfur-containing gases.

### BACKGROUND

Commercial Sulfur Recovery Units (SRUs) implement a Claus reaction for hydrogen sulfide (H₂S) recovery. However, due to the thermodynamic limitations of the Claus reaction, complete H₂S recovery is not achieved. As a result of oxidation of H₂S, a tail gas that includes high amounts of sulfur dioxide (SO₂) is emitted into the atmosphere. Commercial technologies include a tail gas treatment unit (TGT) to reduce SO₂ emissions into the atmosphere. Due to high installation costs and operating costs of the TGT, there is a continuous effort to develop alternative and economically attractive solutions.

### SUMMARY

Implementations described here provide a method for tail gas treatment by a two stage adsorption process which includes intermediate cooling.

The following units are used in this disclosure.

| Imperial Units | Symbol | SI units | Symbol |
|---|---|---|---|
| Fahrenheit | F. | Kelvin/ Celsius | K/° C. |
| Pounds per square | psig | Mega Pascals/bar | MPa/ bar |
| inch gauge | | | |
| Million standard | MMSCFD | Mega Standard | MSm³/d |
| cubic feet per day | | Cubic Meters per | |
| | | day | |
| Pounds per hour | lb/hr | Kilogram per | Kg/hr |
| | | hour | |
| Mole Fraction | Mole Frac | Mole Fraction | Mole Frac |

### BRIEF DESCRIPTION OF DRAWINGS

FIG. 1 is a schematic overview of a tail gas treatment process to remove SO₂.

FIG. 2 is a detailed schematic representation of a tail gas treatment system with an intermediate cooling step and a two-stage adsorption bed.

FIG. 3 is a block flow diagram of the tail gas treatment method to reduce SO₂ emissions.

### DETAILED DESCRIPTION

Implementations described here disclose a method for reducing SO₂ emissions from SRUs. The method involves reducing or hydrolyzing all sulfur species from a tail gas of a Claus process to H₂S. Water is removed from the reduced tail gas by a quench tower and an intermediate cooling step. This is followed by catalytical or thermal oxidation of the sulfur species to SO₂, resulting in an oxidized gas stream. The oxidized gas stream is directed to a two-step adsorption process, where the remaining water is selectively removed in the first adsorption bed and SO₂ is selectively removed in the second adsorption bed. In some implementations, both the beds are regenerated with hot air, which is obtained from the Claus combustion air feed, thereby reducing the energy requirement for the tail gas treatment.

Implementations described here achieve a sulfur recovery of >99.9% by avoiding high SO₂ dissolution in the condensed water. This is achieved by removing most of the condensed water ahead of the oxidation step in the presence of H₂S, as H₂S is less soluble in water. This process reduces the CAPEX and OPEX when compared to the existing technologies. Another advantage of the process is the use of air from the Claus reaction furnace to regenerate the adsorbent beds, thereby reducing SRU capacity.

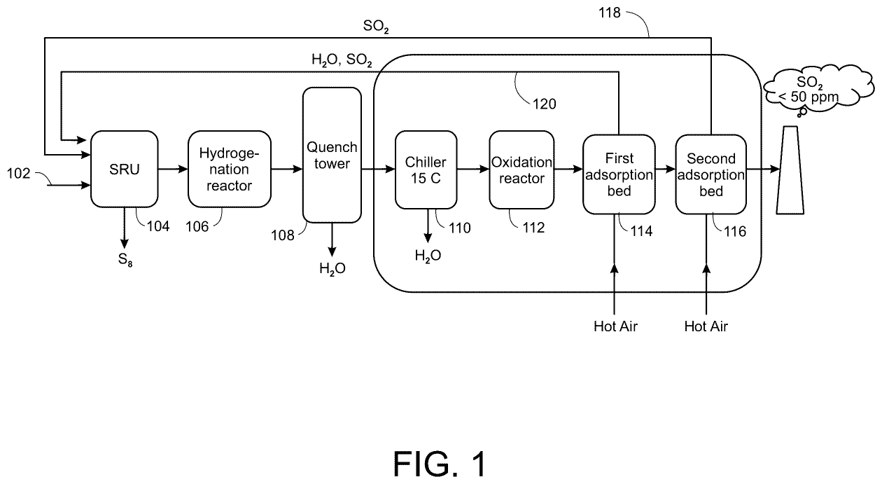

FIG. 1 is a schematic overview of a tail gas treatment process to remove SO₂. An acid gas stream 102 flows into a SRU for the treatment of sulfur containing gases. The acid gas stream 102 includes H₂S, ammonia, hydrocarbons, carbon dioxide (CO₂), and water vapor.

A SRU converts H₂S and other sulfur-containing gases into elemental sulfur. The SRU implements a Claus reaction to convert H₂S into elemental sulfur. The Claus reaction can achieve 95-97% H₂S conversion into elemental sulfur. The unreacted gases from the SRU form a tail gas stream which undergo a tail gas treatment process. The tail gas stream includes CO₂, N₂, water vapor, SO₂, sulfides, and other sulfur vapors that are produced during the Claus reaction. The tail gas stream flows into a hydrogeneration reactor 106.

The hydrogenation reactor 106 reduces sulfur species in the tail gas stream into H₂S by reacting with hydrogen (reducing reaction). The hydrogenation reactor 106 includes a reactor vessel and a catalyst bed that utilizes a solid catalyst for the reduction reaction. The catalyst can include cobalt-molybdenum or nickel-molybdenum supported on alumina. The hydrogenation reaction occurs at a temperature range of 200 to 300° C. An inline burner is used to reheat the tail gas stream and maintain it in reduced conditions. In some implementations, the tail gas stream is heated by a fired gas heater before entering the hydrogenation reactor. The gas stream which exits the hydrogenation reactor 106, includes a mixture of H₂S, hydrogen, water vapor, N₂, and CO₂ and flows towards a quench tower 108.

In the quench tower 108, the temperature of the gas stream from the hydrogenation reactor is cooled down to a temperature of 40-60° C. The quench tower 108 is a column, which can include trays and/or packings. Water is used as a cooling media in the quench tower 108. In some implementations, water flows in a counter current direction to the incoming gas stream. The quench tower 108 can include a packing zone which includes packing materials. The packing zone can include structured or random packing. Some of the packing materials include pall rings, raschig rings, porous plates, metal rings, or ceramic material.

The gas stream entering the quench tower 108 includes about 38-40% water vapor. At least a portion of the water vapor present in the gas stream is removed by condensation. The gas stream exiting the quench tower has about 16-20% water. This gas stream is further processed in a chiller 110.

The chiller 110 cools the gas stream to a temperature ranging between 15-25° C. and further removes water by condensation. In some implementations, the chiller includes multiple heat exchangers connected in series or parallel. Most of the water in the gas stream mixture is formed during the Claus reaction as shown in R.1.

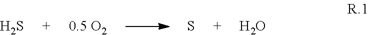

The intermediate water condensation step further reduces the water content in the gas stream and prevents water condensation in the subsequent downstream processes. As the gas stream (H₂S, water vapor, N₂, and CO₂) exits the chiller, the water content in the gas stream ranges between 1.5-2.5% of the total composition

The gas stream that exits the chiller 110 flows into an oxidation reactor 112. The H₂S in the gas stream is oxidized to SO₂ in the oxidation reactor 112. The oxidation reactor 112 includes a tubular reactor, a packed bed reactor, or a fluidized bed reactor. The oxidation reactor 112 includes a catalyst. The catalyst used for the oxidation reaction can include vanadium oxides, chromium oxides, tungsten oxides, cerium oxides, niobium oxides, manganese oxides and copper oxides on a support of alumina, silica, or titania. The oxidation reaction takes place at 200-400° C. In some implementations, oxygen is supplied to the oxidation reactor 112 by an on-site oxygen generator or from an oxygen tank. An excess oxygen ensures complete conversion of H₂S to SO₂.

The oxidized gas stream from the oxidation reactor 112 outlet flows into a first adsorption bed 114. The first adsorption bed 114 includes hydrophilic molecular sieves 3A, which selectively adsorb water. Molecular sieves are crystalline metal aluminosilicates with specific size and porosity designed to adsorb a specific molecule, such as water. Molecular sieves 3A have a pore size of 3 angstrom (Å). The molecular sieves 3A is chosen such that all the remaining water is removed from the oxidized gas stream. It is essential to remove water to avoid the competitive adsorption. Further, this lowers the temperature in the second adsorption bed 116, where SO₂ can be adsorbed. Therefore, removal of any remaining water is performed by the first adsorption bed 114. The rest of the gases such as N₂, CO₂, and SO₂ flow towards the second adsorption bed 116. The second adsorption bed 116 includes hydrophilic molecular sieves 5A, which selectively adsorb SO₂ over CO₂ and N₂. Molecular sieves 5A have a pore size of 5 Å and can selectively adsorb the SO₂ gas molecules.

The adsorption beds are regenerated to desorb the captured molecules. A portion of the hot air that will be used for the Claus unit's reaction furnace is routed to the first and second adsorption beds for the regeneration process. Hot air is supplied by air blowers. During the regeneration of the first adsorption bed 114, water is recovered and removed from the adsorption bed along with the hot air. The recovered water is sent back to the Claus unit. It is further removed by the quench tower 108 or by the chiller 110. During the regeneration of the second adsorption bed 116, SO₂ 118 is eluted from the bed and routed to the Claus unit's reaction furnace. In some implementations, the water and SO₂ streams 120 after regeneration are recycled back to the SRU 104.

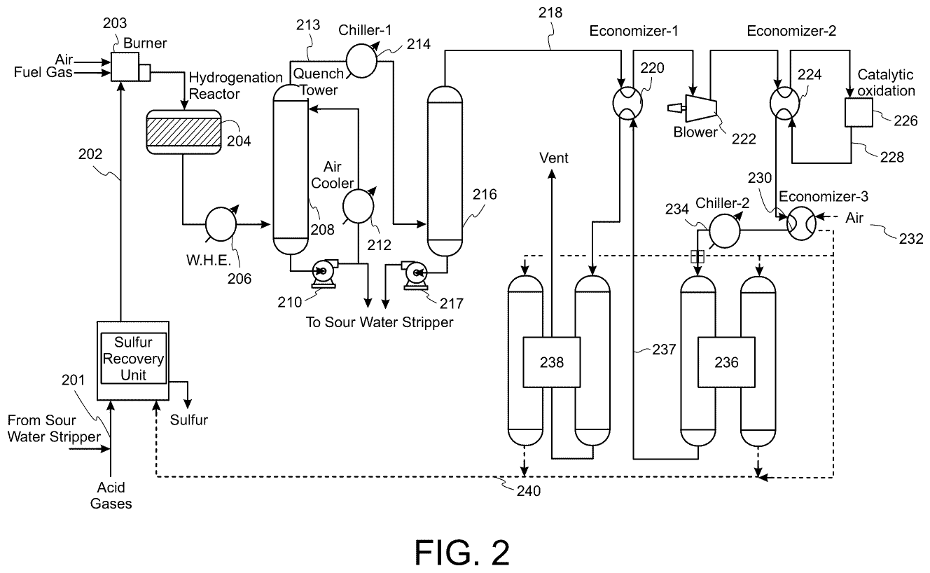

FIG. 2 is a detailed schematic representation of the tail gas treatment system with an intermediate cooling step and a two-stage adsorption bed. A gas mixture 201 that includes an acid gas stream and a gas stream from the sour water stripper is directed to a SRU for sulfur production. The gas stream from the sour water stripper includes H₂S and ammonia. The gas mixture 201 includes H₂S, ammonia, CO₂, water vapor, and a small amount of hydrocarbon gases. In the SRU, a Claus reaction (R.1) is implemented to produce elemental sulfur which is used in various industrial processes. Sulfur is used for the manufacture of dyes, fertilizers, rubbers, and sulfuric acid. At the end of the Claus reaction (R.1), a tail gas stream 202 is produced, which includes unreacted sulfur containing gases like H₂S, SO₂, sulfides, carbonyl sulfide (COS), traces of carbon disulfide (CS₂), sulfur vapors (S₄-S₈), inert gases such as argon and N₂, carbon monoxide (CO), CO₂, and water vapor.

The tail gas stream 202 is heated by an inline burner 203 before being directed to a hydrogenation reactor 204. Air and fuel gas is supplied to the inline burner 203 to heat the tail gas stream 202. As described in FIG. 1, a hydrogenation reactor 204 is a vessel which facilitates the chemical reaction between the sulfur containing gases in the tail gas stream 202 and hydrogen (H₂). The hydrogenation reactor 204 can include a tubular reactor or a packed bed reactor. The packed bed reactor is filled with a catalyst to maximize the contact between the sulfur containing gases and H₂. The catalysts can include cobalt-molybdenum or nickel-molybdenum supported on alumina.

The tail gas stream 202 is heated to a temperature of 250-300° C. In the hydrogenation reactor 204, all the sulfur-containing gases are converted to H₂S at a temperature range of 260-300° C. For example, CS₂ and carbonyl sulfide (COS) are hydrolyzed on the alumina sites to produce H₂S as shown in reactions R.2 and R.3.

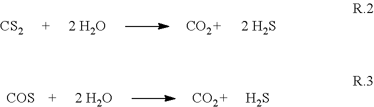

The gas stream exiting the hydrogenation reactor 204 is primarily composed of H₂S along with other gases such as N₂, CO, water vapor, and CO₂. The gas stream from the hydrogenation reactor 204 flows to a waste heat energy recovery system 206, where the excess heat is recovered and used for heating other gas streams in the facility. In some implementations, the excess heat is recovered and used in a boiler to produce high pressure steam. The waste heat recovery system 206 cools the gas stream exiting the hydrogenation reactor 204 to about 135° C., before it enters the quench tower 208.

The gas stream from the waste heat recovery system 206 enters a quench tower 208 and includes about 35-40% water vapor. A quench tower is a column where the temperature of the gas stream is further cooled by a cooling media. The cooling media includes water at a temperature of 40-60° C. In the quench tower, the gas stream is rapidly cooled by a spray of water. In some implementations, water flows in a counter current or co-current direction to cool the incoming gas stream. During the cooling process, water vapor present in the gas stream is condensed and the excess moisture is removed from the gas stream. In some implementations, the quench tower is a vertical tower packed with a packing material. The packing material facilitates contact of the incoming gas stream and the water. The packing material can include pall rings, raschig rings, porous plates, metal rings, clay, graphite, or ceramic material.

The condensed water that exits from the bottom of the quench tower 208 is directed via a pump 210 to a sour water stripper unit. In some implementations, a portion of the condensed water exiting the quench tower 208 is further cooled using an air cooler 212 and recycled as the cooling media for the quench tower 208 operation. Recycling a portion of the condensed water makes the process efficient. The cooled gas stream 213 leaves the quench tower 208 from the top and is directed towards a chiller 214. The cooled gas stream 213 (hereafter referred to as gas stream 213) has about 16-20% water.

As described in FIG. 1, a chiller 214 can include several heat exchangers connected in series or parallel. The chiller 214 reduces the temperature of the gas stream 213 by circulating a chilled liquid coolant through the heat exchangers. This allows for an efficient removal of residual moisture. The role of the chiller 214 is to reduce water content in the gas stream to avoid water condensation in the downstream process. This is essential because any condensed water would solubilize large amounts of SO₂ from the oxidation step that occurs further downstream in the process. It is challenging and energy intensive to remove SO₂ from water and this can hinder the adsorption process.

The chiller 214 reduces the temperature of the gas stream 213 to a temperature of 15-25° C. This removes water by condensation. The cooling process results in the removal of about 14-18% of the total water present in the gas stream 213 After the cooling of the gas stream 213, a gas stream along with condensed water from the chiller 214 is directed towards a water drum 216. In the water drum 216, the condensed water is removed by draining it from the bottom. In some implementations, at least a portion of the condensed water from the water drum 216 is directed to a sour water stripper, via a pump 217.

The gas stream 218 that exits the water drum 216 has a water content ranging between 1.5-2.5% of the total gas composition. The gas stream 218 flows to a first economizer 220, where the temperature is increased to avoid water condensation. An economizer is a tubular heat transfer surface which regulates the temperature of the flowing gas stream. An economizer recovers the waste heat from the incoming gas stream and optimizes the thermal energy of the process. An economizer includes counter current flow heat exchangers for thermal energy recovery. The gas stream 218 passes through a blower 222, where the pressure is increased to facilitate proper circulation to the downstream units. From the blower 222, the gas stream 218 flows to a second economizer 224, where the temperature is further increased to avoid water condensation. From the second economizer 224, the gas stream 218 flows into an oxidation reactor 226.

The oxidation reactor 226 is a reactor vessel in which the H₂S gas is converted into SO₂. As described in FIG. 1, the reactor vessel can include a packed bed or a multitube reactor. A packed bed includes a catalyst bed or a multi-stage catalyst bed. Similarly, a multi tube reactor includes several tubes packed with a catalyst. The catalyst used for the oxidation reaction includes vanadium oxides, chromium oxides, tungsten oxides, cerium oxides, niobium oxides, manganese oxides and copper oxides on a support of alumina, silica, or titania. The oxidation reaction takes place at a temperature range of 200-400° C. During oxidation, 100% of H₂S is the gas stream is converted into SO₂. Water vapor is formed as a byproduct of the reaction.

The gas stream 228, which primarily includes SO₂, N₂, CO₂, and water vapor is directed to a third economizer 230. Air 232 from a Claus combustion unit is supplied to the third economizer 230 via an air feed line. A portion of the air 232 is used to cool the gas stream 228. A portion of the air 232 is used to regenerate the adsorption beds, placed downstream of the oxidation reactor 226.

The gas stream 228 is further cooled by a second chiller 234. This helps with the adsorption of water vapor from the gas stream 228. The water is adsorbed by the first stage adsorption bed 236. The first stage adsorption bed 236 includes hydrophilic molecular sieves 3A, which selectively adsorbs water. As described in FIG. 1, molecular sieves 3A have a pore size of 3 Å. The surface area of the molecular sieve 3A is about 600-700 m²/g. The adsorption takes place at a temperature range of 10-60° C.

The presence of water in the SO₂ gas stream 228 can interfere with the adsorption of SO₂. Therefore, the molecular sieves 3A in the first stage adsorption bed 236 adsorb all the water.

A portion of the air 232 which is used to regenerate the adsorption bed is preheated to a temperature ranging between 200-300° C. It is supplied by air blowers. The preheated air is used to release the adsorbed water from the first stage adsorption bed 236. The water from the first stage adsorption bed 236 is recycled to the SRU along with the air 232.

The gas mixture 237 which include the remaining gases such as N₂, CO₂, and SO₂ flow towards the first economizer 220 before being directed to the second stage adsorption bed 238. The temperature of the gas mixture 237 is reduced by the first economizer 220 to enhance the adsorption capacity by the second stage adsorption bed 238. The second stage adsorption bed 238 includes molecular sieve 5A. Molecular sieve 5A are zeolites that selectively adsorb SO₂ from the gas mixture 237. The remaining gases such as N₂ and CO₂ are vented out of the adsorption system. A portion of the air 232 from the Claus combustion unit is used to regenerate the second stage adsorption bed at a temperature of 200-300° C. to desorb SO₂. The eluted SO₂ is routed to the Claus unit's reaction furnace. The portion of the air 232 used for the regeneration is also recycled back to the Claus unit's reaction furnace.

Tables 1 and 2 show the simulation results for a tail gas treatment in a refinery and gas plant, respectively. The following considerations were made for each case. In the case of a refinery, the SRU treated an acid gas stream and a gas stream from a sour water stripper. The acid gas stream included a high amount of H₂S and negligible amount of CO₂. The gas stream from the sour water stripper primarily included ammonia and H₂S. Therefore, the tail gas stream that entered the treatment system (system described in FIG. 2) had negligible CO₂. There is minimal competition on the SO₂ adsorbent bed due to the negligible amount of CO₂.

In the case of a gas plant, the acid gas stream included higher volumes of CO₂ along with H₂S. This resulted in a tail gas stream with prominent levels of CO₂. The adsorbent bed is designed with a capacity to capture SO₂ selectively over CO₂ from the tail gas stream of a gas plant. In a gas plant, hydrogen is required to condition the hydrogenation catalyst, which is provided by an in-line burner. Tables 2 and 3 show the results of the simulation for both the refinery and gas plant, respectively. COS concentrations after hydrogenation were assumed to be null in the simulations. Any traces of COS (5 ppm-100 ppm) will eventually oxidize and convert to SO₂ and CO₂.

TABLE 1
Simulation—Refinery case

| | | | From | From |
|---|---|---|---|---|
| | Imperial | | Hydro- | Quench |
| | Units | Acid Gas to | genation | Tower to |
| | (SI Units) | SRU | to WHE | Chiller |
| Vapor | | 1 | 1 | 1 |
| Fraction | | | | |
| Temperature | F. (K) | 260.0 (399.8) | 444.7 (503.7) | 140.0 (333.2) |
| Pressure | Psig (MPa) | 15.0 (0.103) | 4.0 (0.027) | 3.0 (0.02) |
| Molar Flow | MMSCFD | 2.52 (0.07) | 6.45 (0.18) | 4.76 (0.13) |
| | (MSm³/d) | | | |
| Mass Flow | lb/hr | 8219.5 | 16445.0 | 13114.9 |
| | (Kg/hr) | (3728.3) | (7459.32) | (5948.8) |
| | Mole Frac | | | |
| Hydrogen | | 0.00050 | 0.04147 | 0.05613 |
| Argon | | 0.00000 | 0.00577 | 0.00781 |
| Oxygen | | 0.00000 | 0.00000 | 0.00000 |
| Nitrogen | | 0.00010 | 0.56562 | 0.76546 |
| Methane | | 0.00060 | 0.00000 | 0.00000 |
| CO₂ | | 0.00030 | 0.00095 | 0.00128 |
| Ethane | | 0.00000 | 0.00000 | 0.00000 |
| H₂S | | 0.73245 | 0.00432 | 0.00584 |
| SO₂ | | 0.00000 | 0.00000 | 0.00000 |
| H₂O | | 0.17117 | 0.38187 | 0.16348 |
| Ammonia | | 0.09450 | 0.00000 | 0.00000 |
| | Imperial | Quench | From Water | KO Drum |
| | Units | Column | KO Drum to | Water |
| | (SI Units) | Water Outlet | Economizer-1 | Outlet |
| Vapor | | 0 | 1 | 0 |
| Fraction | | | | |
| Temperature | F. (K) | 140.0 (333.2) | 60.0 (288.7) | 60.0 (288.7) |
| Pressure | Psig (MPa) | 3.0 (0.02) | 2.5 (0.017) | 2.5 (0.017) |
| Molar Flow | MMSCFD | 1.68 (0.05) | 4.05 (0.11) | 0.72 (0.02) |
| | (MSm³/d) | | | |
| Mass Flow | lb/hr | 3330.1 | 11693.6 | 1421.4 |
| | (Kg/hr) | (1510.5) | (5304.1) | (644.73) |
| | Mole Frac | | | |
| Hydrogen | | 0.00000 | 0.06609 | 0.00000 |
| Argon | | 0.00000 | 0.00920 | 0.00000 |
| Oxygen | | 0.00000 | 0.00000 | 0.00000 |
| Nitrogen | | 0.00000 | 0.90140 | 0.00001 |
| Methane | | 0.00000 | 0.00000 | 0.00000 |
| CO₂ | | 0.00000 | 0.00151 | 0.00000 |
| Ethane | | 0.00000 | 0.00000 | 0.00000 |
| H₂S | | 0.00001 | 0.00687 | 0.00002 |
| SO₂ | | 0.00000 | 0.00000 | 0.00000 |
| H₂O | | 0.99998 | 0.01492 | 0.99998 |
| Ammonia | | 0.00000 | 0.00000 | 0.00000 |
| | | From | From Booster | From |
| | Imperial | Economizer- | to | Economizer-2 |
| | Units | 1 to | Economizer- | to Catalytic |
| | (SI Units) | Booster | 2 | Oxidation |
| Vapor | | 1 | 1 | 1 |
| Fraction | | | | |
| Temperature | F. (K) | 90.0 (305.3) | 214.1 (374.3) | 551.9 (562) |
| Pressure | Psig (MPa) | 2.4 (0.016) | 15.0 (0.103) | 14.5 (0.099) |
| Molar Flow | MMSCFD | 4.05 (0.11) | 4.05 (0.11) | 4.05 (0.11) |
| | (MSm³/d) | | | |
| Mass Flow | lb/hr | 11693.6 | 11693.6 | 11693.6 |
| | (Kg/hr) | (5304.12) | (5304.12) | (5304.12) |
| | Mole Frac | | | |
| Hydrogen | | 0.06609 | 0.06609 | 0.06609 |
| Argon | | 0.00920 | 0.00920 | 0.00920 |
| Oxygen | | 0.00000 | 0.00000 | 0.00000 |
| Nitrogen | | 0.90140 | 0.90140 | 0.90140 |
| Methane | | 0.00000 | 0.00000 | 0.00000 |
| CO₂ | | 0.00151 | 0.00151 | 0.00151 |
| Ethane | | 0.00000 | 0.00000 | 0.00000 |
| H₂S | | 0.00687 | 0.00687 | 0.00687 |
| SO₂ | | 0.00000 | 0.00000 | 0.00000 |
| H₂O | | 0.01492 | 0.01492 | 0.01492 |
| Ammonia | | 0.00000 | 0.00000 | 0.00000 |
| | | From | From | From |
| | Imperial | Catalytic | Economizer-2 | Economizer- |
| | Units | Oxidizer to | to | 3 to |
| | (SI Units) | Economizer-2 | Economizer-3 | Chiller-2 |
| Vapor | | 1 | 1 | 1 |
| Fraction | | | | |
| Temperature | F. (K) | 777.9 (687.5) | 500.0 (533.2) | 410.0 (483.2) |
| Pressure | Psig (MPa) | 13.9 (0.095) | 13.4 (0.092) | 13.2 (0.091) |
| Molar Flow | MMSCFD | 4.78 (0.14) | 4.78 (0.14) | 4.78 (0.14) |
| | (MSm³/d) | | | |
| Mass Flow | lb/hr | 14039.8 | 14039.0 | 14039.0 |
| | (Kg/hr) | (6368.3) | (6368.3) | (6368.3) |
| | Mole Frac | | | |
| Hydrogen | | 0.05597 | 0.05597 | 0.05597 |
| Argon | | 0.00905 | 0.00905 | 0.00905 |
| Oxygen | | 0.02000 | 0.02000 | 0.02000 |
| Nitrogen | | 0.88223 | 0.88223 | 0.88223 |
| Methane | | 0.00000 | 0.00000 | 0.00000 |
| CO₂ | | 0.00289 | 0.00289 | 0.00289 |
| Ethane | | 0.00000 | 0.00000 | 0.00000 |
| H₂S | | 0.00000 | 0.00000 | 0.00000 |
| SO₂ | | 0.00582 | 0.00582 | 0.00582 |
| H₂O | | 0.02404 | 0.02405 | 0.02405 |
| Ammonia | | 0.00000 | 0.00000 | 0.00000 |
| | | From | From | From |
| | | Chiller- | Water | Econo- |
| | | 2 to | Adsorbent | mizer-1 |
| | Imperial | Water | beds to | to SO₂ |
| | Units | Adsorbent | Econo- | Adsorbent |
| | (SI Units) | beds | mizer-2 | beds |
| Vapor | | 1 | 1 | 1 |
| Fraction | | | | |
| Temperature | F. (K) | 90.0 (305.4) | 100.0 (311) | 74.0 (296.5) |
| Pressure | Psig (MPa) | 13.2 (0.091) | 15.2 (0.104) | 15.1 (0.104) |
| Molar Flow | MMSCFD | 4.78 (0.14) | 4.66 (0.13) | 4.66 (0.13) |
| | (MSm³/d) | | | |
| Mass Flow | lb/hr | 14039.0 | 13802.0 | 13802.0 |
| | (Kg/hr) | (6367.9) | (6260.4) | (6260.4) |
| | Mole Frac | | | |
| Hydrogen | | 0.05597 | 0.05736 | 0.05736 |
| Argon | | 0.00905 | 0.00927 | 0.00927 |
| Oxygen | | 0.02000 | 0.02050 | 0.02050 |
| Nitrogen | | 0.88223 | 0.90424 | 0.90424 |
| Methane | | 0.00000 | 0.00000 | 0.00000 |
| CO₂ | | 0.00289 | 0.00296 | 0.00296 |
| Ethane | | 0.00000 | 0.00000 | 0.00000 |
| H₂S | | 0.00000 | 0.00000 | 0.00000 |
| SO₂ | | 0.00582 | 0.00567 | 0.00567 |
| H₂O | | 0.02405 | 0.00000 | 0.00000 |
| Ammonia | | 0.00000 | 0.00000 | 0.00000 |
| | Imperial | From SO₂ | | Air from |
| | Units | Adsorbent | | Econo- |
| | (SI Units) | beds to Vent | Air | mizer-3 |
| Vapor | | 1 | 1 | 1 |
| Fraction | | | | |
| Temperature | F. (K) | 140.0 (333.2) | 140.0 (333.2) | 411.3 (483.7) |
| Pressure | Psig (MPa) | 15.1 (0.104) | 0.0 | 14.8 (0.102) |
| Molar Flow | MMSCFD | 4.63 (0.13) | 4.50 (0.13) | 4.50 (0.13) |
| | (MSm³/d) | | | |
| Mass Flow | lb/hr | 13616.4 | 14301.9 | 14301.9 |
| | (Kg/hr) | (6176.3) | (6487.2) | (6487.2) |
| | Mole Frac | | | |
| Hydrogen | | 0.05769 | 0.00000 | 0.00000 |
| Argon | | 0.00932 | 0.00827 | 0.00827 |
| Oxygen | | 0.02062 | 0.20789 | 0.20789 |
| Nitrogen | | 0.90938 | 0.78384 | 0.78384 |
| Methane | | 0.00000 | 0.00000 | 0.00000 |
| CO₂ | | 0.00298 | 0.00000 | 0.00000 |
| Ethane | | 0.00000 | 0.00000 | 0.00000 |
| H₂S | | 0.00000 | 0.00000 | 0.00000 |
| SO₂ | | 0.00001 | 0.00000 | 0.00000 |
| H₂O | | 0.00000 | 0.00000 | 0.00000 |
| Ammonia | | 0.00000 | 0.00000 | 0.00000 |
| | | Regeneration | Regeneration | |
| | | gas | gas | |
| | Imperial | from H₂O | from SO₂ | |
| | Units | Adsorption | Adsorption | Air to |
| | (SI Units) | beds | beds | SRU |
| Vapor | | 1 | 1 | 1 |
| Fraction | | | | |
| Temperature | F. (K) | 410.5 (483.4) | 411.1 (483.8) | 410.8 (483.6) |
| Pressure | Psig (MPa) | 14.8 (0.102) | 14.8 (0.102) | 14.8 (0.102) |
| Molar Flow | MMSCFD | 2.37 (0.07) | 2.28 (0.06) | 4.64 (0.13) |
| | (MSm³/d) | | | |
| Mass Flow | lb/hr | 7388.0 | 7336.5 | 14724.5 |
| | (Kg/hr) | (3351.1) | (3327.7) | (6678.9) |
| | Mole Frac | | | |
| Hydrogen | | 0.00000 | 0.00000 | 0.00000 |
| Argon | | 0.00786 | 0.00818 | 0.00802 |
| Oxygen | | 0.19767 | 0.20548 | 0.20150 |
| Nitrogen | | 0.74533 | 0.77476 | 0.75976 |
| Methane | | 0.00000 | 0.00000 | 0.00000 |
| CO² | | 0.00000 | 0.00000 | 0.00000 |
| Ethane | | 0.00000 | 0.00000 | 0.00000 |
| H₂S | | 0.00000 | 0.00000 | 0.00000 |
| SO₂ | | 0.00059 | 0.01159 | 0.00598 |
| H₂O | | 0.04854 | 0.00000 | 0.02474 |
| Ammonia | | 0.00000 | 0.00000 | 0.00000 |

TABLE 2
Simulation—Gas plant case

| | | | From | From | Quench |
|---|---|---|---|---|---|
| | Imperial | | Hydro- | Quench | Column |
| | Units | Acid gas | genation | Tower to | Water |
| | (SI Units) | to SRU | to WHE | Chiller | Outlet |
| Vapor | | 1 | 1 | 1 | 0 |
| Fraction | | | | | |
| Temperature | F. (K) | 120.0 (322) | 464.6 (513.5) | 140.0 (333.2) | 140.0 (333.2) |
| Pressure | Psig (MPa) | 15.0 (0.103) | 4.0 (0.027) | 3.0 (0.02) | 3.0 (0.02) |
| Molar Flow | MMSCFD | 37.80 (1.07) | 74.99 (2.12) | 63.34 (1.79) | 11.64 (0.33) |
| | (MSm³/d) | | | | |
| Mass Flow | lb/hr | 154824.0 | 229598.9 | 206566.6 | 23032.3 |
| | (Kg/hr) | (70226.9) | (104144.3) | (93697.0) | (10447.2) |
| | Mole Frac | | | | |
| Hydrogen | | 0.00073 | 0.02039 | 0.02414 | 0.00000 |
| Argon | | 0.00000 | 0.00500 | 0.00592 | 0.00000 |
| Oxygen | | 0.00000 | 0.00000 | 0.00000 | 0.00000 |
| Nitrogen | | 0.00000 | 0.47403 | 0.56115 | 0.00000 |
| Methane | | 0.00140 | 0.00000 | 0.00000 | 0.00000 |
| CO₂ | | 0.40025 | 0.20314 | 0.24046 | 0.00010 |
| Ethane | | 0.00000 | 0.00000 | 0.00000 | 0.00000 |
| H₂S | | 0.55273 | 0.00412 | 0.00488 | 0.00001 |
| SO₂ | | 0.00000 | 0.00000 | 0.00000 | 0.00000 |
| H₂O | | 0.04450 | 0.29332 | 0.16346 | 0.99989 |
| | | From | | | From |
| | | Water KO | | From | Booster |
| | Imperial | Drum to | KO Drum | Econo- | to |
| | Units | Econo- | Water | mizer-1 | Econo- |
| | (SI Units) | mizer-1 | Outlet | to Booster | mizer-2 |
| Vapor | | 1 | 0 | 1 | 1 |
| Fraction | | | | | |
| Temperature | F. (K) | 50.0 (283.2) | 50.0 (283.2) | 89.5 (305.1) | 201.7 (367.4) |
| Pressure | Psig (MPa) | 2.5 (0.017) | 2.5 (0.017) | 2.4 (0.016) | 15.0 (0.103) |
| Molar Flow | MMSCFD | 53.54 (1.51) | 9.80 (0.28) | 53.54 (1.51) | 53.54 (1.51) |
| | (MSm³/d) | | | | |
| Mass Flow | lb/hr | 187166.7 | 19400.0 | 187166.7 | 187166.7 |
| | (Kg/hr) | (84897.3) | (8799.6) | (84897.3) | (84897.3) |
| | Mole Frac | | | | |
| Hydrogen | | 0.02856 | 0.00000 | 0.02856 | 0.02856 |
| Argon | | 0.00701 | 0.00000 | 0.00701 | 0.00701 |
| Oxygen | | 0.00000 | 0.00000 | 0.00000 | 0.00000 |
| Nitrogen | | 0.66389 | 0.00000 | 0.66389 | 0.66389 |
| Methane | | 0.00000 | 0.00000 | 0.00000 | 0.00000 |
| CO₂ | | 0.28443 | 0.00029 | 0.28443 | 0.28443 |
| Ethane | | 0.00000 | 0.00000 | 0.00000 | 0.00000 |
| H₂S | | 0.00576 | 0.00002 | 0.00576 | 0.00576 |
| SO₂ | | 0.00000 | 0.00000 | 0.00000 | 0.00000 |
| H₂O | | 0.01036 | 0.99969 | 0.01036 | 0.01036 |
| Ammonia | | 0.00000 | 0.00000 | 0.00000 | 0.00000 |
| | | From | | From | |
| | | Econo- | From | Econo- | |
| | | mizer-2 | Catalytic | mizer-2 | From |
| | Imperial | to | Oxidizer to | to | Econo- |
| | Units (SI | Catalytic | Econo- | Econo- | mizer-3 |
| | Units) | Oxidation | mizer-2 | mizer-3 | to Chiller-2 |
| Vapor | | 1 | 1 | 1 | 1 |
| Fraction | | | | | |
| Temperature | F. (K) | 538.0 (554.3) | 734.1 (663.2) | 450.0 (505.4) | 367.0 (459.3) |
| Pressure | Psig (MPa) | 14.5 (0.099) | 13.9 (0.095) | 13.4 (0.092) | 13.2 (0.091) |
| Molar Flow | MMSCFD | 53.54 (1.51) | 61.86 (1.75) | 61.87 (1.75) | 61.87 (1.75) |
| | (MSm³/d) | | | | |
| Mass Flow | lb/hr | 187166.7 | 213888.2 | 213924.0 | 213924.0 |
| | (Kg/hr) | (84897.3) | (97018.0) | (97034.2) | (97034.2) |
| | Mole Frac | | | | |
| Hydrogen | | 0.02856 | 0.02471 | 0.02462 | 0.02462 |
| Argon | | 0.00701 | 0.00717 | 0.00717 | 0.00717 |
| Oxygen | | 0.00000 | 0.02000 | 0.02000 | 0.02000 |
| Nitrogen | | 0.66389 | 0.67964 | 0.67976 | 0.67976 |
| Methane | | 0.00000 | 0.00000 | 0.00000 | 0.00000 |
| CO₂ | | 0.28443 | 0.24638 | 0.24636 | 0.24636 |
| Ethane | | 0.00000 | 0.00000 | 0.00000 | 0.00000 |
| H₂S | | 0.00576 | 0.00000 | 0.00000 | 0.00000 |
| SO₂ | | 0.00000 | 0.00499 | 0.00499 | 0.00499 |
| H₂O | | 0.01036 | 0.01710 | 0.01710 | 0.01710 |
| Ammonia | | 0.00000 | 0.00000 | 0.00000 | 0.00000 |
| | | From | From | From | |
| | | Chiller- | Water | Econo- | |
| | | 2 to | Adsorbent | mizer-1 | From SO₂ |
| | Imperial | Water | beds to | to SO₂ | Adsorbent |
| | Units | Adsorbent | Econo | Adsorbent | beds |
| | (SI Units) | beds | mizer-2 | beds | to Vent |
| Vapor | | 1 | 1 | 1 | 1 |
| Fraction | | | | | |
| Temperature | F. (K) | 100.0 (311) | 100.0 (311) | 65.0 (291.5) | 140.0 (333.2) |
| Pressure | Psig (MPa) | 13.2 (0.091) | 15.2 (0.104) | 15.1 (0.104) | 15.1 (0.104) |
| Molar Flow | MMSCFD | 61.87 (1.75) | 60.80 (1.72) | 60.80 (1.72) | 60.50 (1.72) |
| | (MSm³/d) | | | | |
| Mass Flow | lb/hr | 213924.0 | 211722.4 | 211722.4 | 209661.8 |
| | (Kg/hr) | (97034.2) | (96035.6) | (96035.6) | (95100.9) |
| | Mole Frac | | | | |
| Hydrogen | | 0.02462 | 0.02505 | 0.02505 | 0.02517 |
| Argon | | 0.00717 | 0.00730 | 0.00730 | 0.00733 |
| Oxygen | | 0.02000 | 0.02035 | 0.02035 | 0.02045 |
| Nitrogen | | 0.67976 | 0.69177 | 0.69177 | 0.69511 |
| Methane | | 0.00000 | 0.00000 | 0.00000 | 0.00000 |
| CO₂ | | 0.24636 | 0.25071 | 0.25071 | 0.25192 |
| Ethane | | 0.00000 | 0.00000 | 0.00000 | 0.00000 |
| H₂S | | 0.00000 | 0.00000 | 0.00000 | 0.00000 |
| SO₂ | | 0.00499 | 0.00482 | 0.00482 | 0.00000 |
| H₂O | | 0.01710 | 0.00000 | 0.00000 | 0.00000 |
| | | | | Regeneration | Regeneration |
| | | | | gas | gas |
| | Imperial | | Air from | from H₂O | from SO₂ |
| | Units | | Econo | Adsorption | Adsorption |
| | (SI Units) | Air | mizer-3 | beds | beds |
| Vapor | | 1 | 1 | 1 | 1 |
| Fraction | | | | | |
| Temperature | F. (K) | 140.0 (333.2) | 440.9 (500.3) | 438.7 (499.1) | 440.1 (499.8) |
| Pressure | Psig (MPa) | 0.0 (0) | 14.8 (0.102) | 14.8 (0.102) | 14.8 (0.102) |
| Molar Flow | MMSCFD | 45.35 (1.28) | 45.35 (1.28) | 23.75 (0.67) | 22.97 (0.65) |
| | (MSm³/d) | | | | |
| Mass Flow | lb/hr | 144108.6 | 144108.6 | 74256.0 | 74114.8 |
| | (Kg/hr) | (65366.5) | (65366.5) | (33681.9) | (33617.9) |
| | Mole Frac | | | | |
| Hydrogen | | 0.00000 | 0.00000 | 0.00000 | 0.00000 |
| Argon | | 0.00827 | 0.00827 | 0.00790 | 0.00817 |
| Oxygen | | 0.20789 | 0.20789 | 0.19849 | 0.20524 |
| Nitrogen | | 0.78384 | 0.78384 | 0.74841 | 0.77384 |
| Methane | | 0.00000 | 0.00000 | 0.00000 | 0.00000 |
| CO₂ | | 0.00000 | 0.00000 | 0.00000 | 0.00000 |
| Ethane | | 0.00000 | 0.00000 | 0.00000 | 0.00000 |
| H₂S | | 0.00000 | 0.00000 | 0.00000 | 0.00000 |
| SO₂ | | 0.00000 | 0.00000 | 0.00065 | 0.01275 |
| H₂O | | 0.00000 | 0.00000 | 0.04456 | 0.00000 |
| Ammonia | | 0.00000 | 0.00000 | 0.00000 | 0.00000 |

| | Imperial | |
|---|---|---|
| | Units | |
| | (SI Units) | Air to SRU |
| Vapor Fraction | | 1 |
| Temperature | F. (K) | 439.4 (499.5) |
| Pressure | Psig (MPa) | 14.8 (0.102) |
| Molar Flow | MMSCFD | 46.71 (1.32) |
| | (MSm³/d) | |
| Mass Flow | lb/hr (Kg/hr) | 148370.8 (67299.8) |
| | Mole Frac | |
| Hydrogen | | 0.00000 |
| Argon | | 0.00803 |
| Oxygen | | 0.20181 |
| Nitrogen | | 0.76091 |
| Methane | | 0.00000 |
| CO₂ | | 0.00000 |
| Ethane | | 0.00000 |
| H₂S | | 0.00000 |
| SO₂ | | 0.00660 |
| H₂O | | 0.02265 |
| Ammonia | | 0.00000 |

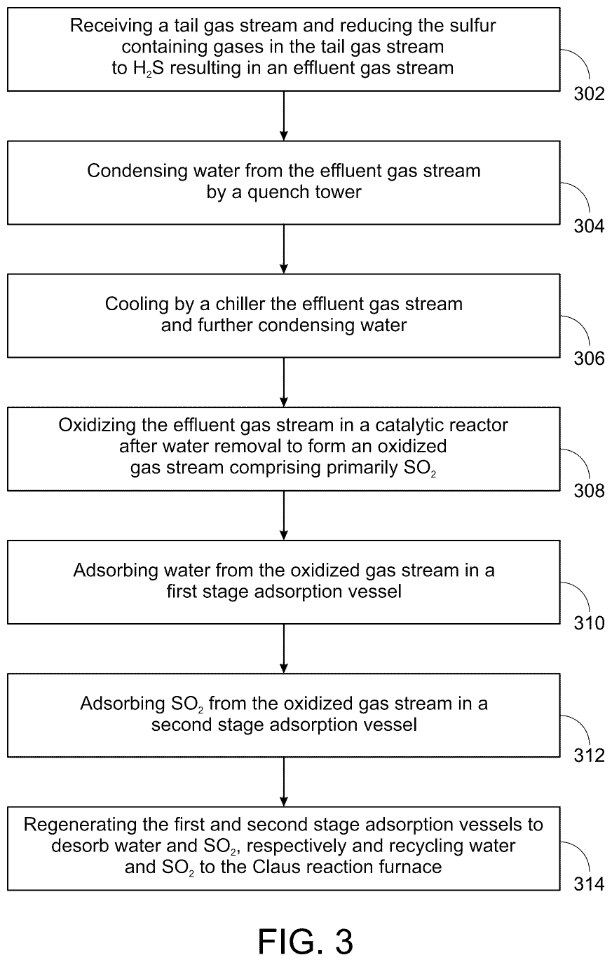

FIG. 3 is a block flow diagram of the tail gas treatment method to reduce SO₂ emissions. At block 302, a hydrogenation reactor receives a tail gas stream. The tail gas stream primarily includes sulfur-containing gases such as SO₂, sulfur vapors, COS, CS₂, SO₂, traces of S₄₋₈, water vapor, N₂, CO, CO₂, and inert gases. The tail gas stream is heated to a temperature of 220-300° C. by a fired heater or an inline burner. Air and fuel are supplied to the inline burner for heating the tail gas stream.

In some implementations, the hydrogenation reactor includes a packed bed reactor or a multitube reactor. Both the reactor types include a catalyst. The catalyst can include cobalt-molybdenum or nickel-molybdenum supported on alumina. The hydrogenation reaction occurs at a temperature range of 200 to 300° C. The hydrogenation reactor 106 reduces sulfur species in the tail gas stream into H₂S by reacting with hydrogen (reducing reaction), resulting in an effluent gas stream. The effluent gas stream primarily includes H₂S, CO₂, N₂, water vapor, and inert gases such as argon. The effluent gas stream flows to a waste heat recovery system, where the temperature is reduced to about 135° C. and thermal energy is recovered. The recovered thermal energy is used for other industrial processes such as heating water in a boiler to produce high pressure steam.

At block 304, the effluent gas stream flows from the waste heat recovery system to a quench tower. The effluent gas stream that flows towards the quench tower includes about 38-40% water vapor. The temperature of the effluent gas stream is reduced to 50-60° C. in the quench tower. As the effluent gas stream cools down, condensation takes place and water is removed from the effluent gas stream. The water is collected at the bottom of the quench tower and directed via a pump to a sour water stripper unit. The cooled effluent gas stream is directed towards a chiller which is placed downstream of the quench tower.

At block 306, the cooled effluent gas stream flows into a chiller. A chiller can include several heat exchangers connected in series or parallel. The chiller further reduces the temperature of the cooled gas stream to about 15-20° C. by circulating a chilled liquid coolant through the heat exchangers. This allows for an efficient removal of residual moisture. A water drum is coupled to the outlet of the chiller to remove the condensed water. The condensed water is directed to the sour water stripper unit.

From the top of the water drum, the gas stream flows to an oxidation reactor. Removal of water from the tail gas stream before oxidation is important, because during the oxidation step SO₂ is formed. SO₂ is highly soluble in water especially in the temperature range of 20-60° C. Due to its high solubility levels, removal of SO₂ from water is challenging and energy intensive. Therefore, it is preferable to condense most of the water upstream of the oxidation step and avoid the gas from reaching its dewpoint later in the process.

At block 308, the gas stream flows to an oxidation reactor. The oxidation reactor can include a packed bed reactor or a multitube reactor. Both the reactor types are filled with a catalyst. The catalyst used for the oxidation reaction can include vanadium oxides, chromium oxides, tungsten oxides, cerium oxides, niobium oxides, manganese oxides and copper oxides on a support of alumina, silica, or titania. The oxidation reaction takes place at 200-400° C. In some implementations, oxygen is supplied to the oxidation reactor by an on-site oxygen generator or from an oxygen tank. In some implementations, oxidation takes place at a high temperature of 350-500° C. (thermal oxidation). The oxidation of H₂S in the dry gas results in SO₂ formation. The outlet gas stream from the oxidation reactor primarily includes SO₂, N₂, CO₂, and any remaining water vapor.

At block 310, a first stage adsorption bed receives the gas stream from the oxidation reactor. The first stage adsorption bed is packed with an adsorbent material. In some implementations, the adsorbent material used is molecular sieves 3A. Water from the gas stream is removed in the first stage adsorption bed. The adsorption process takes place between 10-60° C.

At block 312, a second stage adsorption bed receives the gas stream from the first stage adsorption bed, devoid of water. The second stage adsorption bed is packed with molecular sieves 5A, which selectively adsorbs SO₂ at a temperature ranging between 10-60° C. The remaining gases such as N₂, CO₂, and inert gases are vented out of the second stage adsorption bed.

At block 314, both the first stage and second stage adsorption beds are regenerated to release the adsorbed water and SO₂ gas, respectively. A portion of hot air from a Claus combustion unit flows through an air feed line to the first stage and second stage adsorption bed. The hot air flows at a temperature range of 200-250° C. The combustion air feed line is installed parallel to both the adsorption beds. The hot air is used to regenerate the first stage adsorption bed to release the adsorbed water. The desorbed water is recycled to the Claus unit along with the hot air. Similarly, SO₂ is desorbed from the second stage adsorption bed after regeneration. The eluted SO₂ is routed to the Claus unit along with the hot air.

This technology discloses a method to reduce SO₂ emissions from a tail gas stream. The SO₂ gas is removed from the tail gas stream by an adsorption process. Once the SO₂ gas is desorbed, it is recycled back to the SRU for further sulfur recovery. The advantage of this technology is achieving a sulfur recovery of >99.9%, by condensing most of the water from the tail gas stream, upstream of the oxidation process. SO₂ is highly soluble in water and removing this compound from water is challenging. Therefore, the water is removed ahead of the oxidation step by an intermediate cooling process. This is essential as water can interfere during the adsorption of SO₂. By removing water upstream of the oxidation step, SO₂ adsorption can be performed at a lower temperature, where the adsorbent has a higher capacity without the risk of condensing water. This technology lowers CAPEX and OPEX when compared to the existing technologies.

### EXAMPLES

Certain aspects of the subject matter described here can be implemented as a method to treat sulfur containing gases. A hydrogenation reactor in a tail gas treatment system receives a tail gas stream which includes a mixture of sulfur-containing gases. The hydrogenation reactor reduces the sulfur-containing gases in the tail gas stream to H₂S, resulting in an effluent gas stream that includes H₂S. A quench tower connected to the hydrogenation reactor in the tail gas treatment system condenses water from the effluent gas stream. A chiller connected to and downstream of the quench tower in the tail gas treatment system cools the effluent gas stream to condense water from the effluent gas stream. After condensing water, an oxidation reactor in the tail gas treatment system oxidizes the effluent gas stream to produce an oxidized gas stream that includes SO₂. A first stage adsorption bed placed downstream of the oxidation reactor in the tail gas treatment system adsorbs water from the oxidized gas stream. Following this, a second stage adsorption bed placed downstream of the first stage adsorption bed in the tail gas treatment system adsorbs SO₂ from the oxidized gas stream.

An aspect combinable with any other aspect includes the following features. A fired gas heater of the tail gas treatment system heats the tail gas stream before flowing to the hydrogenation reactor.

An aspect combinable with any other aspect includes the following features. A heated Claus combustion air feed flows through each of the first stage adsorption bed and the second stage adsorption bed to regenerate the first stage adsorption bed and the second stage adsorption bed, respectively.

An aspect combinable with any other aspect includes the following features. A desorbed SO₂ is recycled to a sulfur recovery unit after regenerating the second stage adsorption bed.

An aspect combinable with any other aspect includes the following features. Water from the oxidized gas stream is adsorbed in the first stage adsorption bed using a molecular sieve 3A.

An aspect combinable with any other aspect includes the following features. SO₂ from the oxidized gas stream is adsorbed in the second stage adsorption bed using a molecular sieve 5A.

An aspect combinable with any other aspect includes the following features. The hydrogenation reactor includes a catalyst, where the catalyst includes a cobalt-molybdenum or a nickel-molybdenum supported on alumina.

An aspect combinable with any other aspect includes the following features. The oxidation reactor includes a catalyst, where the catalyst includes vanadium oxides, chromium oxides, tungsten oxides, cerium oxides, niobium oxides, manganese oxides and copper oxides on a support of alumina, silica, or titania.

Certain aspects of the subject matter described here can be implemented as a system to treat sulfur containing gases. The system includes a hydrogenation reactor which receives a tail gas stream, where the sulfur containing gases in the tail gas stream are converted to H₂S, resulting in a gas mixture that includes H₂S. The system further includes a quench tower which is fluidically coupled to the hydrogenation reactor, which receives the gas mixture from which water is condensed. An oxidation reactor is fluidically coupled to the chiller and placed downstream of the chiller, to oxidize H₂S in the gas mixture to sulfur dioxide (SO₂), resulting in a oxidized gas mixture. A first stage adsorption bed is fluidically coupled to the oxidation reactor to adsorb water from the oxidized gas mixture. A second stage adsorption bed placed downstream of the first stage adsorption bed is used to selectively adsorb SO₂ from the oxidized gas mixture.

An aspect combinable with any other aspect includes the following features. The system further includes a gas fired heater upstream of the hydrogenation reactor to increase the temperature of the tail gas stream.

An aspect combinable with any other aspect includes the following features. The first stage adsorption bed includes a hydrophilic molecular sieve 3A.

An aspect combinable with any other aspect includes the following features. The second stage adsorption bed includes a hydrophilic molecular sieve 5A.

An aspect combinable with any other aspect includes the following features. The system further includes a Claus combustion air feed line, where the Claus combustion air feed line is fluidically coupled to the first stage adsorption bed and the second stage adsorption bed.

An aspect combinable with any other aspect includes the following features. The Claus combustion air feed line is configured to supply heated air to regenerate the first stage adsorption bed and the second stage adsorption bed.

An aspect combinable with any other aspect includes the following features. The system further includes a recycle line fluidically coupled to the first stage adsorption bed and the second stage adsorption bed, where the recycle line is configured to flow a desorbed SO₂ to a Claus reaction furnace.

Certain aspects of the subject matter described here can be implemented as a method for SO₂ recovery. The method includes receiving a tail gas stream from a Claus unit, where the tail gas stream includes sulfur-containing gases; reducing or hydrolyzing the sulfur-containing gases in the tail gas stream to hydrogen sulfide (H₂S), resulting in an effluent gas stream; removing moisture from the effluent gas stream by a quench tower; after removing moisture from the effluent gas stream, condensing water from the effluent gas stream in an intermediate chiller; after condensing water from the effluent gas stream, oxidizing the effluent gas stream using a catalyst to form an oxidized gas stream; adsorbing, by a first adsorption bed, water vapor from the oxidized gas stream; adsorbing, by a second adsorption bed, SO₂ from the oxidized gas stream; regenerating the first adsorption bed and the second adsorption bed to desorb water vapor and SO₂, respectively; and after regenerating, recycling the SO₂ to a Claus feed chamber.

An aspect combinable with any other aspect includes the following features. The method further includes regenerating the first adsorption bed and the second adsorption bed using at least a portion of a Claus combustion air feed.

An aspect combinable with any other aspect includes the following features. The first adsorption bed includes a hydrophilic molecular sieve 3A.

An aspect combinable with any other aspect includes the following features. The second adsorption bed includes a hydrophilic molecular sieve 5A.

Other implementations are also within the scope of the following claims.

What is claimed is:

1. A method comprising:
receiving, by a hydrogenation reactor in a tail gas treatment system, a tail gas stream comprising a mixture of sulfur-containing gases;
reducing, by the hydrogenation reactor, the sulfur-containing gases in the tail gas stream to hydrogen sulfide (H₂S) resulting in an effluent gas stream comprising H₂S;
condensing, by a quench tower in the tail gas treatment system, the quench tower connected to the hydrogenation reactor, water from the effluent gas stream;
cooling, by a chiller in the tail gas treatment system, the chiller connected to and downstream of the quench tower, the effluent gas stream to condense water from the effluent gas stream;
after condensing water, oxidizing, by an oxidation reactor in the tail gas treatment system, the oxidation reactor connected to and downstream of the chiller, the effluent gas stream to produce an oxidized gas stream comprising sulfur dioxide (SO₂);
adsorbing, in a first stage adsorption bed in the tail gas treatment system, the first stage adsorption bed coupled to the oxidation reactor, water from the oxidized gas stream; and
adsorbing, in a second stage adsorption bed in the tail gas treatment system, the second stage adsorption bed placed downstream of the first stage adsorption bed, SO₂ from the oxidized gas stream.

2. The method of claim 1, further comprising heating by a fired gas heater of the tail gas treatment system, the tail gas stream before flowing the tail gas stream to the hydrogenation reactor.

3. The method of claim 1, further comprising flowing a heated Claus combustion air feed through each of the first stage adsorption bed and the second stage adsorption bed to regenerate the first stage adsorption bed and the second stage adsorption bed, respectively.

4. The method of claim 3, further comprising heating by a preheater, the Claus combustion air feed before flowing the heated Claus combustion air feed through each of the first stage adsorption bed and the second stage adsorption bed.

5. The method of claim 3, further comprising recycling a desorbed SO₂ to a sulfur recovery unit after regenerating the second stage adsorption bed.

6. The method of claim 1, wherein adsorbing water from the oxidized gas stream in the first stage adsorption bed comprises using a molecular sieve 3A.

7. The method of claim 1, wherein selectively adsorbing SO₂ from the oxidized gas stream in the second stage adsorption bed comprises using a molecular sieve 5A.

8. The method of claim 1, wherein the hydrogenation reactor comprises a catalyst, wherein the catalyst comprises a cobalt-molybdenum or a nickel-molybdenum supported on alumina.

9. The method of claim 1, wherein the oxidation reactor comprises a catalyst, wherein the catalyst comprises vanadium oxides, chromium oxides, tungsten oxides, cerium oxides, niobium oxides, manganese oxides and copper oxides on a support of alumina, silica, or titania.

10. A tail gas treatment system comprising:
a hydrogenation reactor configured to receive a tail gas stream, wherein sulfur-containing gases in the tail gas stream are converted into hydrogen sulfide (H₂S), resulting in a gas mixture comprising H₂S;
a quench tower, fluidically coupled to the hydrogenation reactor, configured to receive the gas mixture, wherein water is condensed from the gas mixture;
a chiller, fluidically coupled to the quench tower, configured to reduce the temperature of the gas mixture to further condense water from the gas mixture;
an oxidation reactor, fluidically coupled to the chiller and placed downstream of the chiller, to oxidize H₂S in the gas mixture to sulfur dioxide (SO₂), resulting in a oxidized gas mixture;
a first stage adsorption bed fluidically coupled to the oxidation reactor to adsorb water from the oxidized gas mixture; and
a second stage adsorption bed, placed downstream of the first stage adsorption bed to selectively adsorb SO₂ from the oxidized gas mixture.

11. The system of claim 10, further comprising a gas fired heater upstream of the hydrogenation reactor to increase the temperature of the tail gas stream.

12. The system of claim 10, wherein the first stage adsorption bed comprises a hydrophilic molecular sieve 3A.

13. The system of claim 10, wherein the second stage adsorption bed comprises a hydrophilic molecular sieve 5A.

14. The system of claim 10, further comprising a Claus combustion air feed line, wherein the Claus combustion air feed line is fluidically coupled to the first stage adsorption bed and the second stage adsorption bed.

15. The system of claim 14, wherein the Claus combustion air feed line is configured to supply heated air to regenerate the first stage adsorption bed and the second stage adsorption bed.

16. The system of claim 10, further comprising a recycle line fluidically coupled to the first stage adsorption bed and the second stage adsorption bed, wherein the recycle line is configured to flow a desorbed SO₂ to a Claus reaction furnace.

17. A method for sulfur dioxide (SO₂) recovery, the method comprising:
receiving a tail gas stream from a Claus unit, wherein the tail gas stream comprises sulfur-containing gases;
reducing or hydrolyzing the sulfur-containing gases in the tail gas stream to hydrogen sulfide (H₂S), resulting in an effluent gas stream;
removing moisture from the effluent gas stream by a quench tower;
after removing moisture from the effluent gas stream, condensing water from the effluent gas stream in an intermediate chiller;
after condensing water from the effluent gas stream, oxidizing the effluent gas stream using a catalyst to form an oxidized gas stream;
adsorbing, by a first adsorption bed, water vapor from the oxidized gas stream;
adsorbing, by a second adsorption bed, SO₂ from the oxidized gas stream;
regenerating the first adsorption bed and the second adsorption bed to desorb water vapor and SO₂, respectively; and
after regenerating, recycling the SO₂ to a Claus feed chamber.

18. The method of claim 17, further comprising regenerating the first adsorption bed and the second adsorption bed using at least a portion of a Claus combustion air feed.

19. The method of claim 17, wherein the first adsorption bed comprises a hydrophilic molecular sieve 3A.

20. The method of claim 17, wherein the second adsorption bed comprises a hydrophilic molecular sieve 5A.
